(19) United States
(12) Patent Application Publication
(10) Pub. No.: US 2010/0257262 A1
(43) Pub. Date: Oct. 7, 2010

(54) APPARATUS AND METHOD FOR SUPPORTING PLURALITY OF DEVICE MANAGEMENT AUTHORITIES

(75) Inventors: Ji-Hye Lee, Suwon-si (KR); Sung-Oh Hwang, Yongin-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/752,687

(22) Filed: Apr. 1, 2010

(30) Foreign Application Priority Data
Apr. 2, 2009 (KR) 10-2009-0028674

(51) Int. Cl. G06F 15/173

(52) U.S. Cl. 709/223

(57) ABSTRACT

A method and an apparatus are provided for supporting a plurality of management authorities in a DM system that includes a plurality of DM servers which manage a DM client and are subordinate to the plurality of management authorities. Priority information of the plurality of management authorities or the plurality of DM servers is stored in a management object. When the DM client receives commands for a specific node from two or more of the plurality of DM servers, the priority information is searched. A command received from one of the two or more DM servers having a high priority according to the priority information is selectively performed.

### PRIORITY

This application claims priority under 35 U.S.C. §119(a) to a Korean Patent Application filed in the Korean Intellectual Property Office on Apr. 2, 2009 and assigned Serial No. 10-2009-0028674, the entire disclosure of which is incorporated herein by reference.

### BACKGROUND OF THE INVENTION

1. Field of the Invention The present invention relates generally to device management, and more particularly, to a technique for supporting device management authorities.

2. Description of the Related Art

Due to the substantial increase in the number of wireless communication terminals, a device management method has been developed for managing firmware, software, parameters, schedules, and hardware capabilities of the terminals, while a wireless enterpriser or a service provider wirelessly communicates with the terminals. The Open Mobile Alliance (OMA) Device Management (DM), developed by the OMA, standardizes applications of wireless communication terminals. The OMA DM may manage the above elements by reading, adding, deleting or changing an object of the terminal using DM protocol based on a synchronization markup language. A management subject of a device, such as a wireless communication terminal, is a DM server, and a management object of the device is a DM client.

A conventional DM method operates peer-to-peer. Specifically, a peer-to-peer session is formed between a DM server on a network and a DM client that is included in a wireless communication terminal to exchange messages defined in DM protocol. The DM server causes the DM client to add, delete or change a specific configuration of the terminal, or to perform a specific operation.

The DM protocol defines 5 messages, from package #0 to package #4. A DM session may be formed between a DM server and a device through the DM protocol. The DM session may be initiated by a DM server or by a DM client (i.e., a device).

FIG. 1 illustrates a general DM session setup process. If a management operation is to be performed for a specific device, a DM server 20 transmits a package #0 notification message to a DM client 10 included in the specific device in step 101. The package #0 notification message informs the DM client 10 that there is a DM action. Upon receiving the package #0 notification message, the DM client 10 transmits a package #1 message to the DM server 20 in step 103. The package #1 message requests the DM server 20 to form a DM session. The DM server 20 permits the DM client 10 to setup the DM session and transmits a package #2 message to the DM client 10 in step 105. The package #2 message sends a DM command for a management operation of a terminal. The DM client 10 transmits a package #3 message to the DM server 20 in step 107. The package #3 sends an execution result of the DM command in response to the package #2 message received from the DM server 20.

The DM server 20 ends the DM session or transmits a package #4 message for an additional management operation to the DM client 10 in step 109. The DM client 10 performs the additional management operation included in the package #4 message and reports a result of the additional management operation to the DM server 20 through the package #3 message. Thereafter, the DM server 20 and the DM client 10 may provide management operations or management commands by exchanging the package #4 message and the package #3 message. If a command for a management operation is still contained in the package #4 message, the DM session is maintained. If there is not a command for an additional management operation, the DM session is ended.

A general relationship between a management authority, DM servers and a DM client that are defined in a DM system is illustrated in FIG. 2. DM client A 200 may be managed by a plurality of DM servers 210, 220 and 230. However, the plurality of DM servers 210, 220 and 230 are subordinate to only management authority A 240. In the DM system of FIG. 2, although there are a plurality of DM servers capable of replacing a value of a specific node, since the plurality of DM servers are all controlled by a single management authority, a command operation may collide.

In the DM system of FIG. 2, since one management authority controls a plurality of

DM servers, an operation of a terminal according to the transmission of commands is smoothly performed. However, in such a DM system, an operation method is proposed on the assumption that the number of management authorities is only one. Therefore, when a plurality of management authorities are present, a method is needed for supporting the plurality of management authorities so that a terminal does not generate an operation error.

### SUMMARY OF THE INVENTION

The present invention has been made to address at least the above problems and/or disadvantages and to provide at least the advantages described below. Accordingly, an aspect of the present invention provides an apparatus and method for supporting a plurality of management authorities to prevent an operation error of a terminal in a DM system.

Another aspect of the present invention provides an apparatus and method for supporting a plurality of management authorities to prevent command collision in a DM system.

According to one aspect of the present invention, a method for supporting a plurality of management authorities in a DM system that includes a plurality of DM servers which manage a DM client and are subordinate to the plurality of management authorities is provided. Priority information of the plurality of management authorities or the plurality of DM servers is stored in a management object. When the DM client receives commands for a specific node from two or more of the plurality of DM servers, the priority information is searched. A command received from one of the two or more DM servers having a high priority according to the priority information is selectively performed.

According to another aspect of the present invention, an apparatus for supporting a plurality of management authorities in a DM system is provided. The apparatus includes a storage for storing priority information of the plurality of management authorities or a plurality of DM servers in a management object. The apparatus also includes a controller for determining whether commands for a specific node are received from two or more of the plurality of DM servers which are subordinate to the plurality of management authorities, searching the priority information when the commands are received, and selectively performing a command received from one of the two or more DM servers having a high priority according to the priority information.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a general DM session setup process;

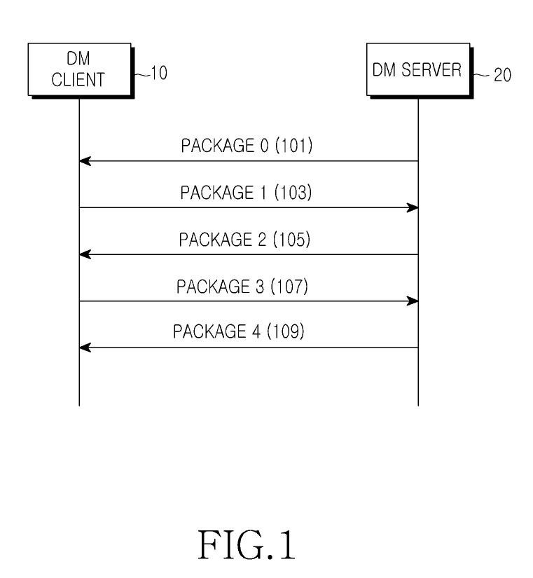

FIG. 2 is a diagram illustrating a DM system showing a general relationship between a management authority, DM servers and a DM client;

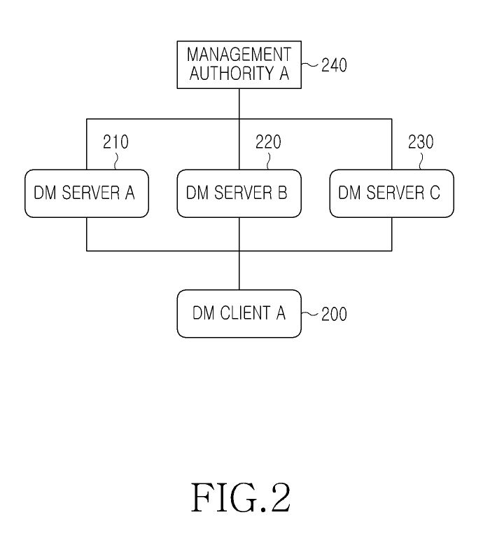

FIG. 3 is a diagram illustrating a DM tree;

FIG. 4 is a diagram illustrating a property of an Access Control List (ACL), according to an embodiment of the present invention;

FIG. 5 is a diagram illustrating a configuration of a DM system showing a relationship between a plurality of management authorities, a plurality of DM servers and a DM client, according to an embodiment of the present invention;

FIG. 6 is a diagram illustrating a process for applying priority of management authorities or DM servers to an access control list, according to an embodiment of the present invention;

FIG. 7 is a diagram illustrating a process for setting an additional node to a management object to store priority information of management authorities or DM servers, according to an embodiment of the present invention; and

FIG. 8 is a flow chart illustrating an operation of a terminal according to priority, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Embodiments of the present invention support a plurality of management authorities to prevent the possibility of command collision in a DM system. Priority information is set in an access control list among property lists of a node. If repeated commands for a specific node are received from a plurality of DM servers, a command from a DM server controlled by a management authority having high priority based on the priority information is performed. Thus, collision is prevented while a command for a specific node is performed.

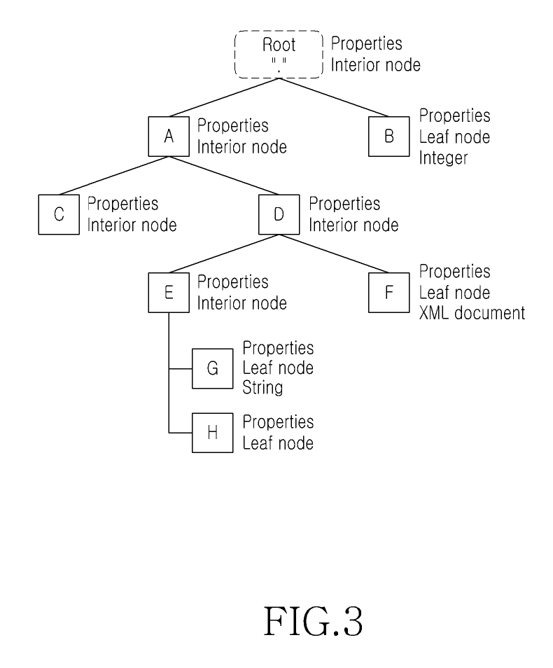

Referring initially to FIG. 3, a diagram illustrates a structure of a DM tree of the interior of a wireless communication terminal including the DM client. A structure of a Management Object (MO) of the interior of a wireless communication terminal is shown in a tree form. The MO is a means for exposing parameters and an object of the interior of the terminal to a DM server.

The MO structure may be defined by anybody, including a service provider, a terminal vendor, etc., and the defined MO structure has a specific MO Identifier (ID) for identification. The MO structure corresponding to the MO ID is registered in a specific server, for example, an Open Mobile Naming Authority (OMNA). Accordingly, the defined MO structure may be represented by an MO ID registered in the OMNA. Specifically, an MO corresponding to one MO ID has the same configuration and structure irrespective of types of wireless communication terminals.

Each element of a DM tree is referred to as a node. The DM tree includes an interior node (A, C, D, E) and a leaf node (B, F, G, H). The interior node has a subordinate child node and cannot store values. The leaf node can store values and does not include a subordinate child node. The leaf node may designate a method for interpreting stored values using a format among the property lists. Each node has effective properties during its existing duration. The property lists are shown in Table 1 below.

TABLE 1

| Property | Explanation |
|---|---|
| ACL | Access Control List |
| Format | Specifies how node values should be interpreted |
| Name | Name of node in tree |
| Size | Size of the node value in bytes |
| Title | Human readable name |
| TStamp | Time stamp, date and time of last change |
| Type | MIME type of leaf node's value or URN representing |
| | MO ID for interior nodes which root MO sub-tree |
| VerNo | Version number, automatically incremented at each |
| | modification |

Among the property lists of a node shown in Table 1, an ACL is used to set priority information according to an embodiment of the present invention. When using the ACL, the priority information is stored with respect to each node.

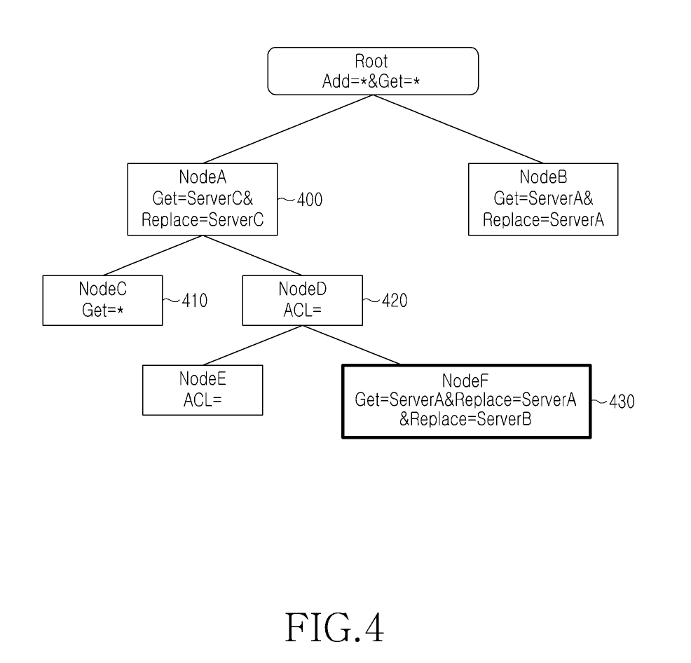

Referring now to FIG. 4, a diagram illustrates a property of the ACL, according to an embodiment of the present invention. A server having authority to access and control each node according to a command may be set, and the set server may be indicated by a server ID. For example, ‘Get’ and ‘Replace’ shown in a node A 400 denote servers to which authority is assigned. The authority of ‘Get’ and the authority of ‘Replace’ are given by a server C. A symbol ‘Get=*’ in a node C 410 indicates that all servers have the authority of ‘Get’. When a value of an ACL is empty as in a node D 420, the node D 420 conforms to a value of the ACL of a parent node, specifically, the node A 400. In a node F 430, the authority of ‘Get’ is given only by a server A, and the authority of ‘Replace’ is given by the server A and a server B.

In setting the ACL of the node F 430, a plurality of DM servers can replace a value of the node F 430. It is assumed that the plurality of DM servers are controlled by one management authority.

Alternatively, the plurality of DM servers may be subordinate to and respectively controlled by different management authorities. For the node F 430, if the server A transmits a ‘Replace’ command by an x value and if the server B transmits a ‘Replace’ command by a y value, it is difficult for a DM client to judge which one of x and y values is used to perform the ‘Replace’ command. Specifically, if commands are received from a plurality of servers that are respectively subordinate to a plurality of management authorities, a terminal may make an operation error due to repeated commands. Therefore a function for controlling the repeated commands is needed.

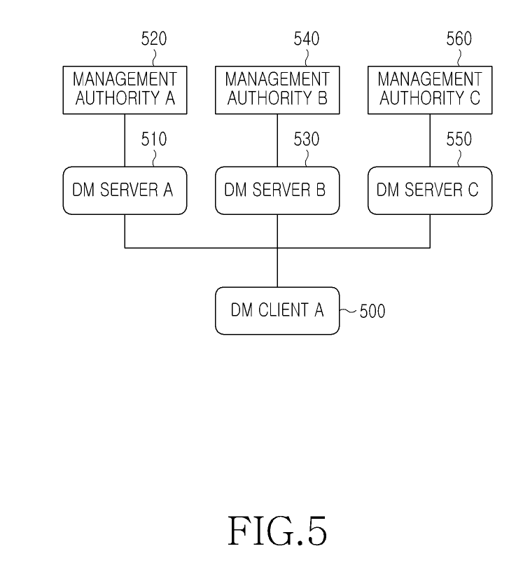

For example, since command operations for the same node may collide, there is a need of a method for adjusting which command is first processed, as described below with respect to FIG. 5.

FIG. 5 is a diagram illustrating a configuration of a DM system showing a relationship between a plurality of management authorities, a plurality of DM servers and a DM client, according to an embodiment of the present invention. A DM client A 500 is managed by a plurality of DM servers, i.e., a DM server A 510, a DM server B 530 and a DM server C 550. The DM servers 510, 530 and 550 are respectively subordinate to a management authority A 520, a management authority B 540 and a management authority C 560. The DM client A 500 includes a storage for storing an MO in which priority information is set, and a controller for processing repeated commands for the same node according to the priority information. The DM servers 510, 530 and 550 are independently controlled by the different management authorities 520, 540 and 560. The management authorities 520, 540 and 560 refer to substantial subjects, such as service providers and network enterprisers, having the authority to manage user terminals.

In an embodiment of the present invention, priority information for the management authorities or the DM servers is assigned. Therefore, even though a terminal receives repeated commands, the terminal performs a command processing operation according to the priority information. The priority information may be stored when information about the management authorities and servers in relation to a corresponding terminal is stored in a management tree. The stored information about the management authorities, servers and priority may be dynamically changed or set according to user preference or business policy of a service provider.

Meanwhile, in an embodiment of the present invention, an ACL of a management tree is used to store the priority information. An example of adding the priority information to the ACL will is described in detail below. When using the ACL included in each node, the possibility of collision of commands for a specific node can be prevented without modifying an existing DM system.

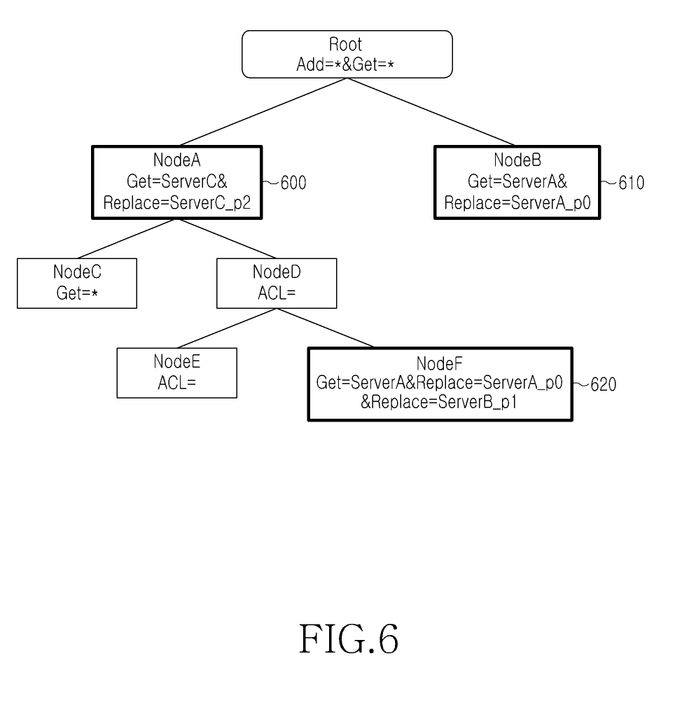

FIG. 6 is a diagram illustrating a process for applying priority of management authorities or DM servers to an ACL, according to an embodiment of the present invention.

Servers A and B belong to different management authorities. It is assumed that priority of the server A is set to 0 and priority of the server B is set to 1 according to user preference or business policy of a service provider. The servers A and B are defined as DM servers having the authority to drive a ‘Replace’ command as in a specific node F 620. ‘Replace=ServerA_p0’ indicates that priority of the server A for a ‘Replace’ command is 0, and ‘Replace=ServerB_p1’ indicates that priority of the server B for the ‘Replace’ command is 1. Such priority information may be stored as a value of an ACL of a node.

If it is defined that the server A has authority over a ‘Replace’ command for a node B 610, since priority of the server A is 0, the ‘Replace’ command for the node B 610 may be indicated by ‘Replace=ServerA_p0’. If only a single DM server is assigned as in a node A 600, priority of a management authority having a corresponding DM server is set to 2 and may be indicated by ‘p2’. Since commands from only one DM server, a server C, can be performed, indication of such priority may be omitted.

If repeated commands for the node F 620 are transmitted from two or more DM servers, specifically, the servers A and B, priority is applied to a terminal. The terminal may perform only a command from a DM server belonging to a management authority having high priority. Accordingly, an operation error due to transmission of repeated commands can be prevented.

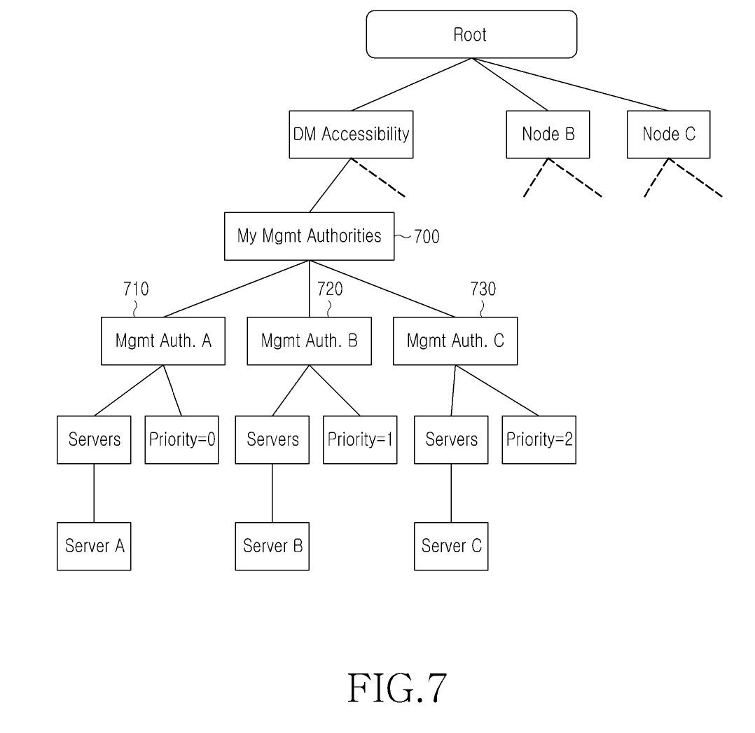

Information about the priority may be stored by designating an additional node and the designated node may be added to an MO. FIG. 7 is a diagram illustrating a process for setting an additional designated node to an MO to store priority information of management authorities or DM servers, according to an embodiment of the present invention.

An MO tree is illustrated in FIG. 7. A node for storing priority information of management authorities or DM servers may be added to an MO. Specifically, an interior node for storing an ACL and priority may be set in the MO tree. All ACLs related to a corresponding terminal may be subordinate as child nodes to ‘my management authorities’. For example, a management authority A 710, a management authority B 720 and a management authority C 730 are subordinate to the management authority node 700 as child nodes. For each of the management authorities 710, 720 and 730, priority information of the management authority and a list of servers that are subordinate to the management authority may be stored as a child node. Thus, an additional node for storing the priority information of management authorities or servers may be added to an MO. A method for adding a node for storing priority to an MO may be dynamically updated and requires only a small storage space.

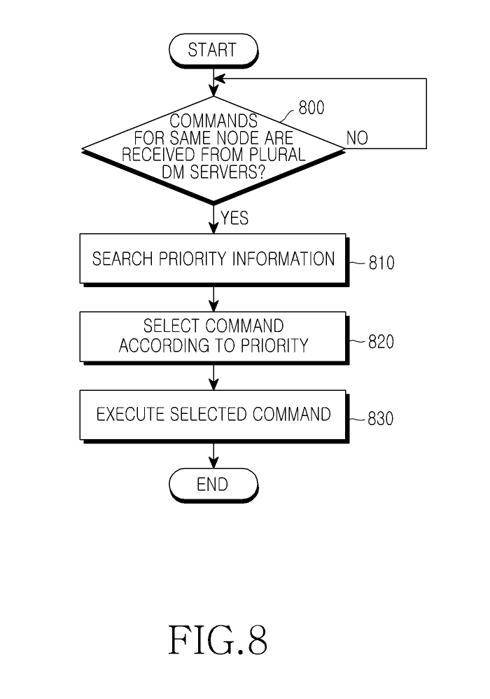

Referring now to FIG. 8, a flow diagram illustrates an operation flow of a terminal according to priority, according to an embodiment of the present invention. A terminal determines whether commands for the same node are received from a plurality of DM servers in step 800. If commands are received from a plurality of DM servers, the terminal searches priority information in step 810. According to an embodiment of the present invention shown in FIG. 6, when repeated commands for the node F 620 are received from two or more DM servers, specifically, the servers A and B, the terminal acquires priority information of the servers A and B by confirming a stored value of an ACL of the node F 620 in an MO. According to another embodiment of the present invention shown in FIG. 7, when repeated commands for the node F 620 are received from the servers A and B, the terminal acquires priority information of the servers A and B by confirming an ACL and priority information stored in an additional node, specifically, the management authority node 700 in an MO. The terminal may determine which server has high priority based on the priority information. Therefore, the terminal selects a command according to priority in step 820. The terminal selects a command from a DM server belonging to a management authority having high priority. The terminal performs the selected command in step 830. Thus, even though there are plurality of management authorities, the access authority of each management authority is set differently by assigning priority. Therefore, a terminal can process repeated commands for a specific node.

According to embodiments of the present invention, priority information is added to an ACL, and therefore, a collision that may be generated while a terminal performs commands for a specific node can be prevented without modifying an existing DM system. Further, priority information of each management authority can be dynamically changed by a method for storing and managing an ACL of management authorities and DM servers related to a corresponding terminal in an MO. The priority can be set according to user preference or business policy of a service provider.

While the invention has been shown and described with reference to certain embodiments thereof, it will be understood by those skilled in the art that various changes in form and detail may be made therein without departing from the scope and spirit of the invention as defined by the appended claims.

What is claimed is:

1. A method for supporting a plurality of management authorities in a Device Management (DM) system that includes a plurality of DM servers which manage a DM client and are subordinate to the plurality of management authorities, the method comprising the steps of:
storing priority information of the plurality of management authorities or the plurality of DM servers in a management object;
when the DM client receives commands for a specific node from two or more of the plurality of DM servers, searching the priority information; and
selectively performing a command received from one of the two or more DM servers having a high priority according to the priority information.

2. The method of claim 1, wherein the priority information is added to an access control list among property lists of each node.

3. The method of claim 1, wherein storing the priority information comprises adding a node for storing the priority information of the plurality of management authorities or the plurality of DM servers to the management object.

4. The method of claim 1, wherein the priority information is changed according to a user preference or a business policy of a service provider.

5. An apparatus for supporting a plurality of management authorities in a Device Management (DM) system, the apparatus comprising:
a storage for storing priority information of the plurality of management authorities or a plurality of DM servers in a management object; and
a controller for determining whether commands for a specific node are received from two or more of the plurality of DM servers which are subordinate to the plurality of management authorities, searching the priority information when the commands are received, and selectively performing a command received from one of the two or more DM servers having a high priority according to the priority information.

6. The apparatus of claim 5, wherein the priority information is added to an access control list among property lists of each node.

7. The apparatus of claim 5, wherein the storage for storing the priority information comprises means for adding a node for storing the priority information of the plurality of management authorities or the plurality of DM servers to the management object.

8. An apparatus for supporting a plurality of management authorities in a Device Management (DM) system, the apparatus comprising:
a management object for storing priority information of the plurality of management authorities or a plurality of DM servers; and
a terminal for determining whether commands for a specific node are received from two or more of the plurality of DM servers which are subordinate to the plurality of management authorities, searching the priority information when the commands are received, and selectively performing a command received from one of the two or more DM servers having a high priority according to the priority information.
